(19) United States
(12) Patent Application Publication
(10) Pub. No.: US 2024/0384741 A1
(43) Pub. Date: Nov. 21, 2024

(54) FASTENER HOLDER, MOUNTING SYSTEM AND METHOD OF MOUNTING A FASTENER

(71) Applicant: Kamax Holding GmbH & Co. KG, Homberg (Ohm) (DE)

(72) Inventors: Jan Herbert, Marburg (DE); Andreas Mohr, Amoneburg-Mardorf (HU); Frank Mertens, Meschede (DE); Dennis Netten, Finnentrop (DE)

(73) Assignee: Kamax Holding GmbH & Co. KG, Homberg (Ohm) (DE)

(21) Appl. No.: 18/560,024

(22) PCT Filed: May 10, 2022
(86) PCT No.: PCT/EP2022/062669

§ 371 Date: Nov. 9, 2023

(30) Foreign Application Priority Data
May 10, 2021 (DE) 102021112102.7

(51) Int. Cl. F16B 19/02; F16B 41/00

(52) U.S. Cl. CPC F16B 19/02; F16B 41/002

(57) ABSTRACT

Fastener holder (1) comprising a base body (10) and at least one assembly structure (50), wherein the base body (10) extends in a longitudinal direction (L), wherein the base body (10) has a reception breakthrough (12), wherein the reception breakthrough (12) extends completely through the base body (10), wherein the reception breakthrough (12) has an inner wall (14) formed rotationally symmetrically about the longitudinal direction (L), wherein the assembly structure (50) extends transversely to the longitudinal direction (L).

The invention relates to a fastener holder and mounting system and a method of mounting a fastener.

Screws and other fasteners, such as bolts, are already known from the prior art. These are used to clamp a first component to a second component. For this purpose, the bolts are inserted into a hole in the first component and then screwed with the thread in the bolt into a nut thread, e.g. in the second component. However, the problem is that the bolt easily falls out of the hole in the first component if the bolt is not immediately screwed into the nut thread. In complex manufacturing processes in particular, this can lead to bolts being lost, because the assembly step of screwing does not usually take place directly after insertion in the hole of the first component.

It is therefore the object of the invention to provide a means of permitting simple assembly of fasteners which, in addition, is also cost-effective.

This object is solved with a fastener holder according to claim 1 and with a mounting system according to claim 14 and by a method for mounting a fastener according to claim 15. Further advantages, features and advantageous embodiments result from the subclaims, the description and the figures.

According to the invention, a fastener holder is provided. The fastener holder may comprise a base body and/or at least one assembly structure, wherein the base body extends in a longitudinal direction, wherein the base body has a reception breakthrough, wherein the reception breakthrough extends completely through the base body, wherein the reception breakthrough has an inner wall formed substantially rotationally symmetrical about the longitudinal direction, wherein the assembly structure extends transversely to the longitudinal direction. The fastener holder according to the invention serves to hold or place a fastener, such as a screw or bolt, in a mounting hole without the need for the fastener to be screwed. In other words, fastener holders according to the invention, for example or advantageously, do not serve to transmit an operating load between the fastener and the or a component. Therefore, fastener holders advantageously serve only to temporarily support the fastener and/or to support the fastener against its own weight. In other words, the fastener holder is thus, in particular in one embodiment, a temporary fixing means or a temporary fixing or holding means. The mounting hole of the fastener holder may be, for example, an elongated hole, a bore or other recess or aperture. Expediently, the mounting hole has an internal thread in its inner wall and/or is preferably completely free of internal threads. By means of the fastener holder according to the invention, a pre-placement of a fastener in a mounting hole can be carried out in a particularly simple manner, wherein at a later time the fastener held by the fastener holder can be finally screwed. The fastener holder has a base body. This base body is in particular one or the main component or in particular the central component of the fastener holder. The base body extends in the longitudinal direction. The longitudinal direction is expediently the direction in which the main body has its largest main dimension and/or in which the length of the main body is determined and/or in which the reception breakthrough extends. The reception breakthrough penetrates the base body in the longitudinal direction, in particular completely. Expediently, a radial direction extends perpendicular to the longitudinal direction and a circumferential direction extends circumferentially around the longitudinal direction. In other words, the longitudinal direction, the radial direction and the circumferential direction may form a cylindrical coordinate system with each other, wherein the longitudinal direction is the height coordinate, the radial direction is the radial coordinate and the circumferential direction is the angular coordinate. As already explained, the fastener holder according to the invention has a reception breakthrough which extends completely through the base body. The reception breakthrough serves—in a holding state—to receive the fastener and to exert a holding force on the fastener, thus preventing the fastener from falling out of the reception breakthrough. This holding force can be achieved, for example, by means of an interference fit or press fit between the fastener and the reception breakthrough. The reception breakthrough is formed substantially rotationally symmetrical about the longitudinal direction and therefore has an inner wall formed substantially rotationally symmetrical about the longitudinal direction. By “substantially rotationally symmetrical” it can be understood in particular that the reception breakthrough is formed rotationally symmetrical about the longitudinal direction except for minor manufacturing tolerances and/or minor formations, such as an internal thread. Alternatively, or additionally preferred, the reception breakthrough can also be formed completely rotationally symmetrical about the longitudinal direction. By this essentially rotationally symmetrical design, a particularly cost-effective design of the reception breakthrough can be achieved, which can nevertheless reliably exert a holding force on a fastener. Designed transversely to the longitudinal direction, the fastener holder has at least one assembly structure. The assembly structure therefore extends in particular radially away from the base body. The at least one assembly structure, preferably the plurality of assembly structures, serve to come into contact with the mounting hole (or a mounting hole) in a mounted state in such a way that they form or provide a holding force in interaction with the mounting hole, in particular due to the existing friction. In other words, in an assembled state, the assembly structures form an at least non-positive holding connection with the mounting hole, so as to prevent the fastener holder and the fastener from falling out at least non-positively, in particular exclusively non-positively or non-positively and positively. The assembly structures can be designed in particular as planar structures, for example as ears, flaps, flaps or as radially circumferential flange elements or as a radially circumferential flange. By a planar structure it can be understood in particular that the main direction of extension of the object or the dimension in this direction is in particular greater than in the longitudinal direction. Alternatively, by a planar structure it can also be understood that the dimensions which are perpendicular to the direction of the material strength are at least as large, preferably twice as large, particularly preferably at least three times as large, as the material strength of the planar element or component. Alternatively, or additionally preferably, the assembly structures can also be formed as, preferably separate, flange segments. The radially bounding end regions of the assembly structures, in particular of the flange segments and/or of the flange, are preferably designed to contact, in an assembled state, the mounting hole in which the fastener is to be held. By means of the fastener holder according to the invention, a particularly simple assembly or provision of holding force for a fastener can be achieved, wherein, in addition, the fastener holder results in a particularly cost-effective design of the fastener holder due to the substantially rotationally symmetrical design of the reception breakthrough about the longitudinal direction or of the inner wall of the reception breakthrough.

Advantageously, the inner wall surrounds the longitudinal direction. In other words, the inner wall can be designed in such a way that it forms a contour in a sectional plane perpendicular to the longitudinal direction which is completely closed, wherein the longitudinal direction is arranged within this contour. Particularly or alternatively preferably, the center of the inner wall lies on the longitudinal direction. This leads to a particularly simple production and thus to a cost reduction of the fastener holder.

Advantageously, the center of gravity of the base body and/or the assembly structures and/or the fastener holder lies on the longitudinal direction. By arranging the center of gravity of the base body and/or the assembly structures or the fastener holder on the longitudinal direction, a particularly balanced and easy-to-handle structure of the fastener holder can be achieved, so that both the casting production and a possible handling of the fastener holder can be facilitated.

Advantageously, the base body has an outer wall that is rotationally symmetrical about the longitudinal direction, in particular a cylindrical outer wall. This makes it possible to achieve a structure of the base body that is particularly easy to manufacture and can withstand particularly high mechanical loads. Expediently, this rotationally symmetrically formed outer wall can limit only a part of the base body in the longitudinal direction outwardly in the radial direction. Alternatively, or additionally preferably, the base body may completely comprise an outer wall formed rotationally symmetrically about the longitudinal direction along the longitudinal direction, wherein this rotational symmetry is only destroyed by the assembly structure or the connection regions of the assembly structures. In other words, this can mean that, for example, the base body is completely rotationally symmetrical on the outside except for the areas that are connected to the assembly structures.

Advantageously, the assembly structure or the assembly structures have a material strength—in particular as viewed in the longitudinal direction—wherein the material strength is smaller than the length of the base body in the direction of the longitudinal direction. In other words, the material strength of the assembly structures, in particular of all assembly structures, or of at least one assembly structure may be smaller than the length of the base body which the latter has in the longitudinal direction. Expediently, the material strength is thereby the thickness of the assembly structure, in particular in the longitudinal direction. Alternatively, or additionally preferably, the material strength can also be that dimension in which the assembly structure has its smallest main dimension. By providing a material strength of the assembly structures which is smaller than the length of the main body in the longitudinal direction, it can be achieved that a particularly cost-effective design of the fastener holder is achieved and, moreover, a large degree of flexibility of the assembly structure or the assembly structures can also be achieved thereby, so that a particularly simple insertion of the fastener holder into a mounting opening or a mounting hole can be achieved. Preferably, the material strength of the assembly structure or the assembly structures, which can also be referred to as the material strength, is in a range of 0.3 to 8 mm, particularly preferably in a range of 0.4 to 2 mm and especially strongly preferably in a range of 0.7 to 1.2 mm.

In an advantageous embodiment, the ratio of the material strength of the assembly structure to the diameter of the reception breakthrough is in a range from 0.05 to 0.3, preferably in a range from 0.07 to 0.25 and particularly preferably in a range from 0.09 to 0.2. The diameter of the reception breakthrough is in particular the nominal diameter of the reception breakthrough and/or the diameter of the smallest possible circle in a sectional plane which can just surround the reception breakthrough, wherein the sectional plane is in particular perpendicular to the longitudinal direction. If the ratio is in the range of 0.05 to 0.3, a particularly good holding force development and thus a particularly high degree of holding ability for a fastener by means of the fastener holder in a mounting hole can be achieved. However, should the ratio be in a range of 0.07 to 0.25, the applicant has surprisingly found that a particularly simple and inexpensive manufacture can be achieved thereby. However, in order to achieve a particularly high degree of adaptability, especially with regard to angular compensation, of the fastener, the ratio should be in a range of 0.09 to 0.2. The decisive material strength is in particular the average material strength of the assembly structure along its course; advantageously, the connection section of the assembly structure is not included in the determination of the material strength.

It may be particularly preferable for the material strength to decrease continuously in the radial direction. In this way, a design particularly adapted to the mechanical load can be achieved. Alternatively, the material strength can also be constant in the radial direction. In this way, particularly simple and cost-effective production can be achieved.

Expediently, at least one assembly structure, preferably the major part of the assembly structures, and particularly preferably all assembly structures, extends substantially perpendicularly, preferably perpendicularly, to the longitudinal direction. By substantially perpendicular it is to be understood that the smaller angle between the enclosed directions may not be less than 60°, preferably 80°, particularly preferably 85° and especially strongly preferred 88°. By providing assembly structures extending substantially perpendicularly to the longitudinal direction, on the one hand a simple manufacture and, moreover, also a high degree of holding force can be provided or achieved. The direction of extension is to be understood in particular as the direction or the course of extension which points or runs from the connection region of the assembly structures to the distal ends of the assembly structures, in particular those which extend freely. In other words, the longitudinal dimension of the assembly structure may extend perpendicularly or at least substantially perpendicularly to the longitudinal direction.

It is expedient that the assembly structures form the radial distal region of the fastener holder. In this context, the radial distal regions are those regions of the fastener holder which are spaced furthest from the longitudinal direction in the radial direction. In other words, the distal end regions in the radial direction of the fastener holder are formed by the assembly structures. This can ensure or achieve particularly good holding force development and particularly simple assembly of the fastener holder.

Advantageously, the assembly structure and/or the assembly structures have an outer surface bordering in a radial direction, the contour of the outer surface forming a projection rounding radius in a projection plane, wherein the projection plane is spanned in particular by the longitudinal direction and the radial direction. Due to the rounded design of the radially bordering areas of the assembly structures, a particularly good mounting and holding force development can be achieved, because the outer surface which is to contact the mounting hole is already “pre-fitted” to the contour of the mounting hole. Expediently, the center of one, in particular all, projection radii lies on the longitudinal direction.

In a preferred embodiment, the ratio of the diameter of the reception breakthrough to the projection rounding radius is in a range from 0.6 to 1.8, preferably in a range from 0.7 to 1.5 and particularly preferably in a range from 0.8 to 1.3. By forming the ratio in a range from 0.6 to 1.8, a particularly good holding force development can be provided. However, should the ratio be in a range of 0.7 to 1.5, a particularly easy-to-manufacture variant of a fastener holder can be achieved here. However, should the ratio be in a range of 0.4 to 1.3, assembly of the fastener holder may be simplified thereby because the applicant has surprisingly found that a particularly convenient assembly force requirement for the user results thereby. In other words, a particularly easy-to-mount device can be achieved hereby.

Expediently, the ratio of the diameter of the outer wall to the projection rounding radius lies in a range from 1.05 to 3.33, preferably in a range from 1.25 to 2.5 and particularly preferably in a range from 1.5 to 2.0. By forming the ratio in a range from 1.05 to 3.33, a particularly good holding force development can be provided. However, should the ratio be in a range of 1.25 to 2.5, a particularly easy-to-manufacture variant of a fastener holder can be achieved here. However, should the ratio be in a range of 1.5 to 2.0, assembly of the fastener holder may be simplified thereby because the applicant has surprisingly found that a particularly convenient assembly force requirement for the user results thereby. In other words, a particularly easy-to-mount device can be achieved hereby.

Preferably, the assembly structure, preferably the predominant number of assembly structures and particularly preferably all assembly structures, have a connection section, wherein the assembly structure is/are connected to the base body via the connection section, wherein the connection section can have a connection fillet, in particular a connection hollow, wherein the connection fillet has a fillet radius. The connection section may also be referred to as a connection region or section. By providing a connection section on the assembly structure, a particularly mechanically loadable and compact design of the fastener holder can be achieved. By providing a connection hollow in the connection section, the mechanical load capacity, in particular the fatigue strength, of the fastener holder can also be increased. The fillet radius of the connection hollow of the connection section is determined in particular in a plane which is spanned by the radial direction and the longitudinal direction. Furthermore, by forming the connection section as a hollow, the notch effect factor can also be reduced.

In a preferred embodiment, the ratio of the throat radius to the diameter of the reception breakthrough is in a range from 0.05 to 0.3, preferably in a range from 0.09 to 0.25, and particularly preferably in a range from 0.09 to 0.2. Should the ratio of the throat radius to the diameter be in a range of 0.05 to 0.3, a particularly resilient and yet elastic connection of the assembly structure to the base body can be achieved, so that a particularly good holding force development or a particularly good provision of a holding force for a fastener to be accommodated in the fastener holder can be achieved hereby. In order to be able to achieve a particularly low notch effect and thus a particularly high degree of fatigue strength, the ratio should be in a range from 0.09 to 0.25. However, if the ratio is in a range of 0.09 to 0.2, the applicant has surprisingly found that a particularly advantageous manufacturing method can be achieved, in particular by means of injection molding, so that this results in a particularly cost-effective fastener holder.

Advantageously, the fastener holder has at least one passage opening, preferably a plurality of passage openings, wherein at least one of the passage openings, preferably all passage openings, is/are formed in the assembly structure and/or between assembly structures. In other words, one or more passage openings may be provided which extend through a assembly structure or are formed between assembly structures. The passage openings serve to allow moisture to pass through or past the assembly structures to prevent corrosion. The passage openings can be formed in such a way that they completely penetrate the assembly structures, in particular in the longitudinal direction. Alternatively, or additionally preferably, the or some of the passage openings can be designed in such a way that they separate the assembly structures from one another. For example, passage openings can be made in the radial end regions of the assembly structures in such a way that two assembly structures are formed from one assembly structure by the passage opening. In addition to the effect of moisture permeability, an increase in the flexibility of the assembly structures can be achieved through the passage openings, in particular through radial passage openings.

Advantageously, the, in particular at least three, passage openings are arranged equidistantly in a circumferential direction. By “arranged equidistantly in the circumferential direction” it can be understood that the angle between the passage openings is always the same in the circumferential direction. For example, with three passage openings, the angle between the passage openings can therefore always be 120°. Due to the equidistant arrangement of the passage openings, a particularly good centering effect of the fastener to be mounted can be achieved by the fastener holder in the mounting hole.

In a preferred embodiment, the passage openings separate the assembly structures or at least two assembly structures from each other in the circumferential direction. Separation in this context means that the passage openings create independent assembly structures, in particular different radial distal regions of the assembly structures. In other words, at one extreme, the passage openings can be formed in such a way that the assembly structures are completely independent of each other mechanically. In other words, the passage openings can be formed in such a way that the assembly structures are no longer connected to each other in any way-except via a connection in an indirect manner via the base body. By separating the assembly structures in this way through the passage openings, the flexibility and elasticity of the assembly structures can be increased, so that easier assembly is possible, while at the same time a high holding force can be provided.

It is expedient that the assembly structure or the assembly structures and/or the base body are formed in one piece, wherein advantageously the entire fastener holder can be formed in one piece. A particularly mechanically loadable structure can be achieved by the one-piece design. Expediently, it is particularly preferred if the entire fastener holder and/or the assembly structures are formed in one piece together with the base body. In this context, a one-piece design means in particular that the relevant components or elements have been or are produced by means of a single master molding process.

Advantageously, the assembly structure or structures and/or the base body are formed from a polymer, in particular from a rubber, advantageously from a synthetic rubber and/or from a metal. By forming by means of a polymer, a particularly cost-effective variant of the fastener holder can be achieved. However, should a rubber be used, a particularly flexible adaptation possibility of the fastener holder or of the assembly structures and/or of the base body to the respective complementary component, in particular to the mounting hole and/or to the fastener, can be achieved. Should a synthetic rubber be used, this results in a particularly simple and cost-effective production of the fastener holder or the respective component, which is made of the synthetic rubber. If, alternatively or additionally, at least one of the components is preferably made of metal, this can increase the mechanical strength of the fastener holder.

In an advantageous embodiment, the assembly structure(s) and/or the base body are made of EPDM and/or the synthetic rubber is an EPDM. An EPDM, which may also be referred to as ethylene propylene diene rubber, can provide a high degree of UV resistance, so that the shelf life of the fastener holder can be increased by EPDM. In addition, this can also provide that the flexibility of the fastener holder and/or the element, which is made of an EPDM, is present even in cold conditions. This circumstance can be particularly decisive with regard to providing the holding force for the fastener to be held in winter.

Expediently, the fastener holder has at least two, preferably at least three, and particularly preferably a plurality of, rows of assembly structures in the longitudinal direction. This makes it possible to provide a particularly high degree of holding force. By the term assembly structure row it is to be understood in particular that a row of assembly structures is formed when there is a plane which is perpendicular to the longitudinal direction, in which several independent and/or interconnected assembly structures are present. Advantageously, several rows of assembly structures-spaced apart from each other in the longitudinal direction—are present. For example, such a row of assembly structures can therefore be formed in that three radially outwardly pointing assembly structures, in particular in the form of flaps, are provided in one plane. Advantageously, a second assembly structure row of the same or similar design can be provided at a distance from this first assembly structure row in the longitudinal direction in order to increase the holding force that can be provided. Alternatively, or additionally preferably, the advantages arising herefrom can also be achieved by arranging a plurality of fastener holders in series in the longitudinal direction in a mounted state on the fastener. The advantage of two or more fastener holders compared to only one fastener holder with two or more assembly structure rows is that they can be easily force demolded, resulting in less expensive and simpler manufacturing.

Another aspect of the invention may relate to a mounting system. This mounting system comprises in particular a fastener, advantageously a screw or a bolt, and at least one fastener holder as described above and below. By means of such a mounting system, in particular the advantages described above and below can be achieved. Expediently, the mounting system may further comprise a clamping component which comprises a mounting hole. This mounting hole can in particular be designed without an internal thread or have an internal thread along its extension. Expediently, the fastener and/or the fastener holder is arranged at least partially within the mounting hole.

Advantageously, the fastener has an external thread, wherein the external thread has a diameter, wherein the external thread is in particular a metric or an imperial thread, and/or wherein expediently the ratio of the diameter of the reception breakthrough to the thread diameter may be in a range from 0.7 to 0.95, preferably in a range from 0.75 to 0.92, and particularly preferably in a range from 0.8 to 0.9. In other words, the fastener may have an external thread, wherein said external thread has a nominal diameter. In order to achieve a particularly diverse and cost-effective usability of the mounting system, the external thread should be a metric or an imperial thread. Should the ratio of the diameter of the mounting hole to the thread diameter of the external thread be in a range of 0.7-0.95, a particularly simple installation of the fastener in the fastener holder can be achieved by this. However, if the ratio is in the range of 0.75-0.92, a particularly high level of holding force between the fastener holder and the fastener can be achieved.

Expediently, the fastener is accommodated in the reception breakthrough. This allows a particularly simple and fast assembly of the mounting system in a component to be braced or in a mounting hole. Therefore, valuable time and/or costs can be saved by such a pre-assembly of the mounting system. The reception breakthrough can thereby be referred to as the mounting hole and vice versa.

In an advantageous embodiment, the mounting system comprises two, preferably three or a plurality, of fastener holders as described above and below. In this way, the holding force provided by the mounting system for the fastener can be further increased in an effective and simple manner. Advantageously, the fastener holders can be arranged in such a way that they make contact with each other in an assembled state. This can increase the compactness of the mounting system.

Another aspect of the invention may relate to a method of assembling a fastener. Advantageously, such a method comprises the steps of:
Providing a fastener;
Providing a fastener holder, particularly as described above and below; and
Inserting the fastener into the reception breakthrough of the fastener holder.

Such a method can in particular achieve the advantages described above and below. Expediently, such a method for mounting a fastener can comprise the further method step of inserting the fastener holder into a mounting opening or a mounting hole, in particular of a component to be braced. In this context, the method may also have the preceding and subsequently described features of the devices in at least an equivalent manner.

A further aspect of the invention may relate to the use of a fastener holder as described above and below for holding a fastener, in particular a screw or bolt. The advantages and features already described above and below may likewise be achieved thereby.

Further advantages and features of the present invention will be apparent from the following description with reference to the figures. Individual features of the embodiments shown can thereby also be used in other embodiments, unless this has been expressly excluded. Showing:

FIG. 1 an isometric view of a fastener holder;

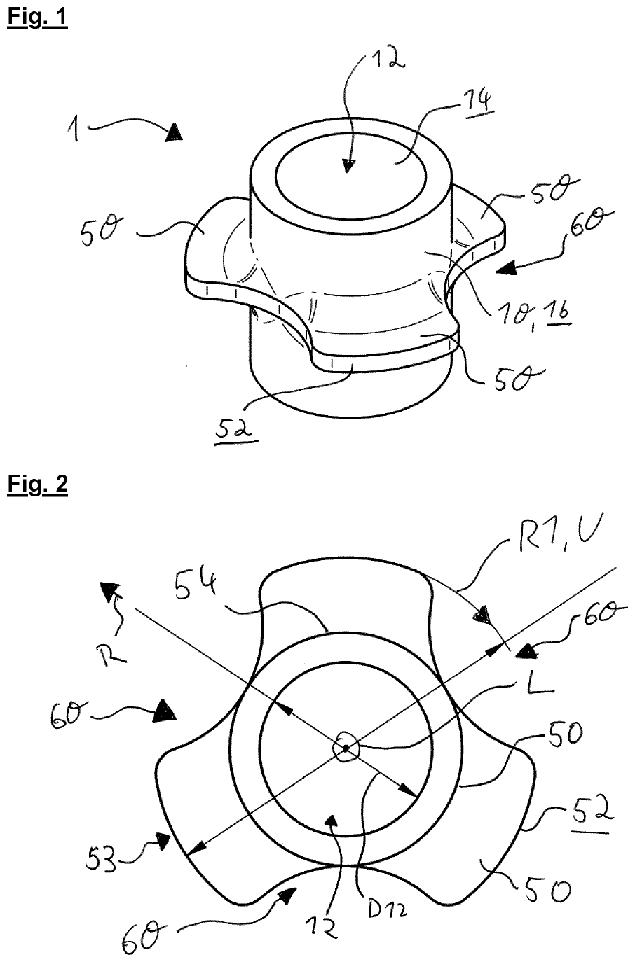

FIG. 2 a view in longitudinal direction of a fastener holder;

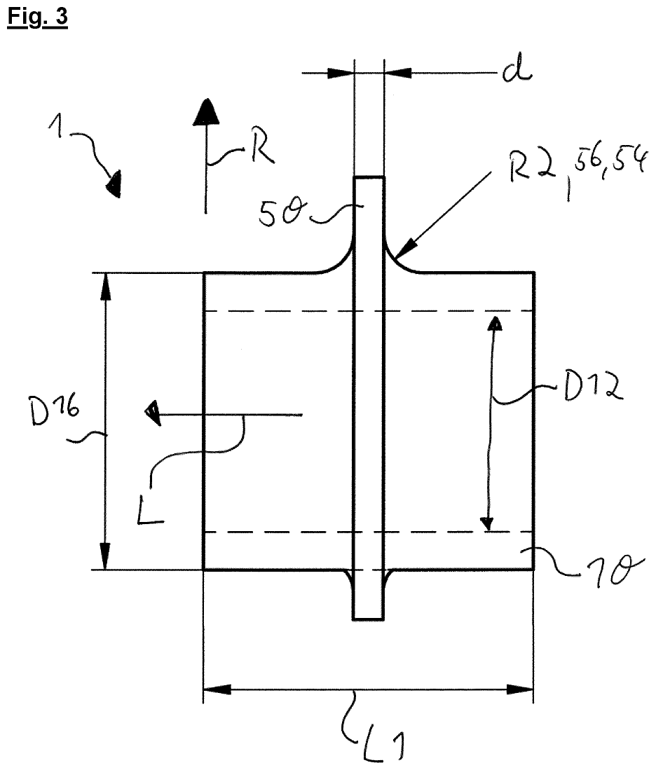

FIG. 3 a side view or a sectional view of a fastener holder;

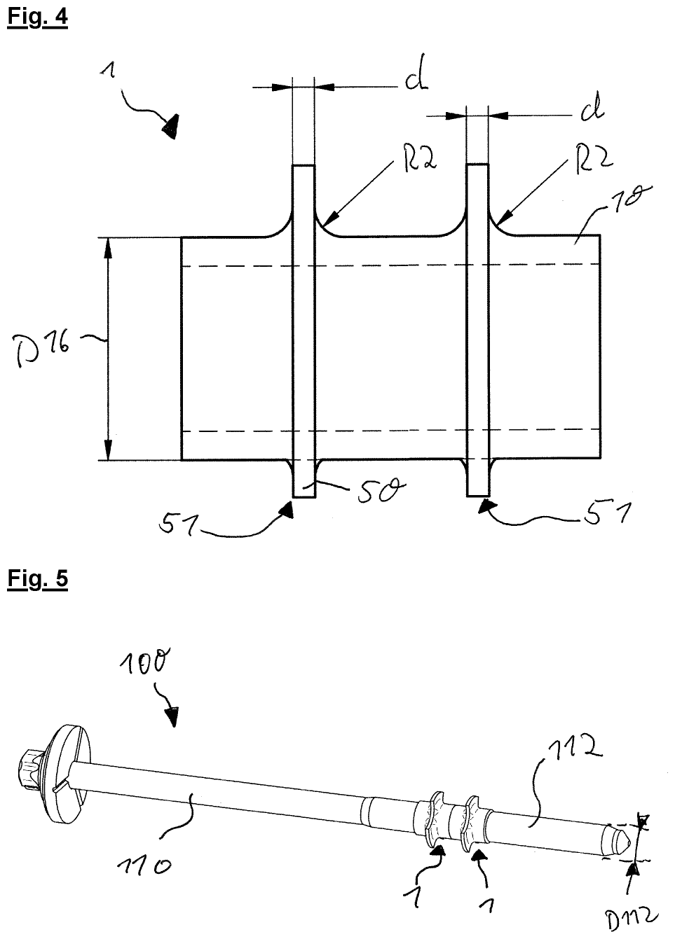

FIG. 4 a side view or sectional view of a further fastener holder; and

FIG. 5 a mounting system.

FIG. 1 shows a fastener holder 1. The fastener holder 1 comprises a base body 10 and three assembly structures 50, which extend transversely to the longitudinal direction L. The base body 10 has a cylindrical outer wall 16. The base body 10 has a cylindrical outer wall 16, as well as a reception breakthrough 12, which has an inner wall 14 formed symmetrically about the longitudinal direction L. The assembly structures 50 are separated from each other in the circumferential direction U by the passage openings 60. The assembly structures 50 each have an outer surface 52 bordering in a radial direction R.

FIG. 2 shows a view of a fastener holder 1, wherein the viewing direction in FIG. 2 is directed against the longitudinal direction L. Radially extending away from the longitudinal direction L is the radial direction R. Circumferentially around the longitudinal direction L is the circumferential direction U. In principle, the embodiment shown in FIG. 2 may be suitable for FIG. 1 and/or for the embodiment shown in FIG. 3. The three assembly structures 50 of the fastener holder 1 extend in the radial direction R and are each connected to the base body 10 via a connection section 54. The assembly structures 50 have an outer surface 52 bordering in the radial direction R, wherein the contour of the outer surface 52 forms a projection rounding radius R1 in the projection plane shown in FIG. 2. The outer surface 52 thereby forms a part of each of the radial distal regions 53 of the assembly structures 50. Between the assembly structures 50 there is in each case a passage opening 60, which is introduced radially from the outside and extends in the longitudinal direction L. Centrally located in the base body 10 is the reception breakthrough 12, wherein the center of the reception breakthrough 12 lies on the longitudinal direction L.

FIG. 3 shows a side view of a fastener holder 1. In FIG. 3, the outer diameter D16 of the outer wall 16 of the base body 10 can be seen. As can be seen from FIG. 3, the longitudinal direction L is perpendicular to the radial direction R. The assembly structures 50 shown in FIG. 3 have a material strength d and the connection section 54, which is formed as a connection hollow 56, has a fillet radius R2. The fastener holder 1 has a length L1 of the base body 10 in the longitudinal direction L.

FIG. 4 shows an alternative embodiment of a fastener holder 1, wherein the embodiment shown in FIG. 4 differs primarily from the embodiment shown in FIG. 3 in that there are multiple rows of assembly structures 51 in FIG. 4.

FIG. 5 shows a mounting system 100 comprising a fastener 110 and two fastener holders 1. In the embodiment shown, the fastener 110 is a screw, in particular a high-strength screw. The fastener 110 has an external thread 112, which has a thread diameter D112. The two fastener holders 1 are applied to the external thread 112 of the fastener 110. The axial cover surfaces of the respective base bodies 10 of the fastener holders 1 make contact with each other, so that the fastener holders 1 are arranged directly adjacent to each other on the external thread 112 of the fastener 110.

### LIST OF REFERENCE SIGNS

1-Fastener holder
10-Base body
12-Reception breakthrough
14-Inner wall
16-Outer wall
50-Assembly structure
51-Assembly structure rows
52-Outer surface
53-Radial distal regions
54-Connection section
56-Connection hollow
60-Passage opening
100-Mounting system
110-Fasteners
112-External thread
d-Material strength
D12-Diameter of the reception breakthrough 12
5 D16-Diameter of the outer wall 16
L-Longitudinal direction
L1-Length of the base body
R-Radial direction
R1-Projection rounding radius
10 R2-Throat radius
U-Circumferential direction

1. A mounting system comprising:
a fastener and at least one fastener holder,
wherein the fastener holder comprises a base body and at least one assembly structure,
wherein the base body extends in a longitudinal direction,
wherein the base body has a reception breakthrough,
wherein the reception breakthrough extends completely through the base body,
wherein the reception breakthrough has an inner wall formed substantially rotationally symmetrically about the longitudinal direction,
wherein the assembly structure extends transversely to the longitudinal direction, and
wherein there is an interference fit between the fastener and the reception breakthrough.

2. The mounting system of claim 1,
wherein the fastener is a screw or a bolt.

3. The mounting system of claim 2,
wherein the assembly structure has a material strength,
wherein the material strength is less than the length of the base body in the direction of the longitudinal direction.

4. The mounting system of claim 3,
wherein the ratio of the material strength of the assembly structure to a diameter of the reception breakthrough is in a range from 0.05 to 0.3.

5. The mounting system of claim 2,
wherein the at least one assembly structure extends substantially perpendicular to the longitudinal direction.

6. The mounting system of claim 2,
wherein the assembly structure forms the radial distal regions of the fastener holder.

7. The mounting system of claim 2,
wherein the assembly structure has an outer surface bordering in a radial direction,
wherein a contour of the outer surface forms a projection rounding radius in a projection plane,
wherein the projection plane is spanned by the longitudinal direction and the radial direction.

8. The mounting system of claim 7,
wherein the ratio of a diameter of the reception breakthrough to one and/or the projection rounding radius is in a range from 0.6 to 1.8.

9. The mounting system of claim 2,
wherein the assembly structure comprises a connection section,
wherein the assembly structure is connected to the base body via the connection section,
wherein the connection section has a connection fillet,
wherein the connection fillet, has a fillet radius.

10. The mounting system of claim 2,
wherein the fastener holder comprises at least one passage opening,
wherein the at least one passage opening is formed in or between assembly structure.

11. The mounting system of claim 2,
wherein the at least one passage opening separates the at least one assembly structure in a circumferential direction.

12. The mounting system of claim 2,
wherein the assembly structure and the base body are formed in one piece.

13. The mounting system of claim 2,
wherein the assembly structure and/or the base body is/are formed from a polymer.

14. The mounting system of claim 2,
wherein the fastener holder comprises in longitudinal direction at least two assembly structure rows.

15. A method of assembling a fastener, the method comprising the steps of:
providing a fastener, wherein the fastener is a screw or a bolt;
providing a fastener holder,
wherein the fastener holder comprises a base body and at least one assembly structure,
wherein the base body extends in a longitudinal direction,
wherein the base body has a reception breakthrough,
wherein the reception breakthrough extends completely through the base body,
wherein the reception breakthrough has an inner wall formed substantially rotationally symmetrically about the longitudinal direction,
wherein the assembly structure extends transversely to the longitudinal direction; and
inserting the fastener into the reception breakthrough of the fastener holder so that an interference fit is achieved between the fastener and the reception breakthrough.
